(19) United States
(12) Patent Application Publication
(10) Pub. No.: US 2006/0251786 A1
(43) Pub. Date: Nov. 9, 2006

(54) Cyclopropanated coumarin derivatives

(76) Inventor: Luca Turin, London (GB)

Correspondence Address: MILES & STOCKBRIDGE PC, 1751 PINNACLE DRIVE, SUITE 500, MCLEAN, VA, 22102-3833, US

(21) Appl. No.: 11/406,494

(22) Filed: Apr. 19, 2006

Related U.S. Application Data
(60) Provisional application No. 60/672,521, filed on Apr. 19, 2005.

(51) Int. Cl. A23L 1/22

(52) U.S. Cl. 426/536

(57) ABSTRACT

This invention provides compound or a mixture of compounds of formula (I): 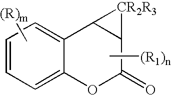
wherein R and R₁ are independently a substituted or unsubstituted, straight or branched alkyl or alkoxy group having up to 5 carbons, phenyl or substituted phenyl; R₂ and R₃ are each independently H or CH₃; m is an integer from 0 to 4, and n is an integer from 0 to 2. A method for the synthesis of these compounds is also provided, as is their use as aromachemicals and flavorants and compositions, products and articles containing them.

The present invention relates to derivatives of coumarin aromachemicals. Novel fragrance and flavor aromachemicals are disclosed herein as well as methods of making them, their use as aromachemicals and articles of manufacture including them. These novel derivatives find utility in any and all applications requiring certain aroma themes. The invention also relates to mixtures of these derivatives, methods for their preparation and their use as perfume materials for application to a variety of substrates.

Coumarin and its common related compounds are essential components of the Fougere fragrance family, that also includes oak moss, lavender and sometimes geranium oil. Coumarin has a hay-like odor that has proven very popular for men's fragrances and in tobacco products. Coumarin, also known as 1,2-benzopyrone [CAS Registry number 91-64-5] has the structure:

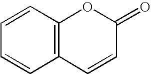

Coumarin has been banned as a food additive in many countries since the mid-20^{th} century due to its toxicity to the liver and kidneys. More recently, it has also been banned by tobacco companies as an adulterant to most tobacco products. Compounds related to coumarin have also been banned from cosmetic products.

It is also reported that “coumarin is also an anticoagulant that represses the synthesis of prothrombin, a plasma protein produced in the liver in the presence of vitamin K”, see for example http://waynesword.palomar.edu/chemid2.htm.

Derivatives of coumarin that have found use in the aromachemical industry include 6-methylcoumarin (Sweet Coconut Vanilla Creamy Powdery Floral), 7-methylcoumarin (duplicates the flavor characteristics of natural deertongue leaves or ground tonka beans; used as tobacco flavorant) 4,6-dimethyl-8-tert-butylcoumarin (tobacco flavorant), 7-methoxycoumarin (useful as tobacco flavorant) and 4-methyl-7-ethoxycoumarin. Coumarin has also itself been used as a tobacco additive to improve the taste of nicotine and enhance the fragrance and taste characteristics of a variety of tobacco products.

Coumarin epoxide has been implicated in hepatoxocity and genotoxicity. See EFSA Journal (2004) 104, 1-36; Vassallo et al, Toxicological sciences, 82, 26-33 (2004); Born et al, Drug Metabolism and Disposition, 25, 1318-1323 (1997); Born et al, Drug Metabolism and Disposition, 28, 218-223 (2000) and Vassallo et al, Toxicological sciences, 80, 249-257 (2004). Coumarin was voluntarily withdrawn from sale for use in foods due to the discovery of its toxicity to humans. Its use had been increasing as a food additive. Laboratory studies revealed “impressive evidence” of the capacity of coumarin to produce serious damage to the liver of experimental animals when these animals were fed comparable amounts of coumarin that were added to human food. FDA banned its use as a food additive on Mar. 5, 1954 (19 Federal Register 1239). See also,
http:/www.fda.gov/ora/inspect_ref/iom/APPENDICES/appA3.html;
http://www.cspinet.org/reports/chemcuisine.htm;
http://www.foodsafetysite.com/consumers/faq/index.html?m_knowledgebase_article=316 “ - - - Coumarin is an FDA-banned substance that can cause internal hemorrhaging, liver damage and possible cancer - - - ”.

Derivatives of coumarin that have found use in the aromachemical industry include 6-methylcoumarin (Sweet Coconut Vanilla Creamy Powdery Floral), 7-methylcoumarin (duplicates the flavor characteristics of natural deertongue leaves or ground tonka beans; used as tobacco flavorant) 4,6-dimethyl-8-tert-butylcoumarin (tobacco flavorant), 7-methoxycoumarin (useful as tobacco flavorant) and 4-methyl-7-ethoxycoumarin. Coumarin has also itself been used as a tobacco additive to improve the taste of nicotine and enhance the fragrance and taste characteristics of a variety of tobacco products. The use of coumarin in tobacco products, over which the FDA has no jurisdiction, has caused much controversy and has been all but discontinued over much of the world.

Thus, “ - - - concern (has been expressed) over the use of coumarin in pipe tobacco - - - ”-http://www.tobaccofreekids.org/reports/insider/deposition_{—}12.shtml. James A. Duke states in Handbook of Medicinal Herbs (Boca Raton, Fla.: CRC Press, 1985), p 491:“Leaves (containing coumarin) used to flavor pipe and cigar tobacco and cigarettes . . . and as a moth repellant . . . may cause hemorrhage and liver damage”. Gosselin, Smith, Hodge, and Braddock, Clinical Toxicology of Commercial Products, 5th ed (Baltimore: Williams & Wilkins, 1984), at page II-4 lists toxicity levels of 1-6 (1, “practically non-toxic”; 4, “very toxic”; 6, “super-toxic”); nicotine, item 772, pages II-237 and III-311-4 is rated a 6; coumarin, page II-257, item 861, is a 4. Robert Dreisbach and William Robertson, Handbook of Poisoning. Prevention, Diagnosis and Treatment, 12th ed (Norwalk, Conn.: Appleton & Lange, 1983 and 1987), at pages 385-7, cover coumarin.

Jay Arena and Richard Drew, Poisoning, 5th ed (Springfield, Ill.: Charles C. Thomas Pub, 1986), at page 999, which lists coumarin, says, ominously, “see Warfarin,” p 1007. It has been reported that “ - - - in the USA from 1954 until 1985 when coumarin was reportedly removed from domestic cigarettes, but not from pipe tobacco until 1996” [http://www.ncbi.nlm.nih.gov/entrez/query.fcgi?cmd=Retrieve&db=PubMed&list_uids=1466 0776&dopt=Abstract]. At http://waynesword.palomar.edu/chemid2.htm: it is reported that “coumarin is also an anticoagulant that represses the synthesis of prothrombin, a plasma protein produced in the liver in the presence of vitamin K. Prothrombin is the precursor of the enzyme thrombin which catalyzes the conversion of fibrinogen to fibrin in the clotting process. Threads of fibrin wind around blood platelets in the damaged area of a blood vessel and provide the framework of a blood clot. Coumarin is converted into the anticoagulant dicoumarin during the improper curing of sweet clover hay from species of Melilotus. Hemorrhaging and death may occur in cattle that eat spoiled sweet clover hay, depending on the amount consumed. Dicoumarin and related drugs are used in human medicines as blood thinners and are commonly used in rodent poisons such as Decon®, which literally cause rats to bleed to death - - - .” A Missouri Attorney General's Office News Release in 2000 stated, “ - - - Big Tobacco laced their products with Coumarin, a type of rat poison, because they thought it would make menthol and other brands taste better - - - [http://www.ago.state.mo.us/newsreleases/2000/090600.htm]. The Louisville Courier-Journal reported that “ - - - Coumarin, a common tobacco sweetener, was (known by big tobacco to be a) lung-specific carcinogen - - - ” [http://www.aph.org/aphnew/sweet16.html]. University of Oklahoma Press Release [http://www.aph.org/aphnew/sweet16.html]: “Peer Reviewed Article Documents Placement of Highly Toxic Coumarin in Tobacco Products” by big tobacco. “ - - - Coumarin has been adequately tested by oral administration in two experiments in mice and in one experiment in rats. In mice of one strain, it produced increases in lung tumours (adenomas and carcinomas) in both males and females and in hepatocellular adenomas in females - - - ” [http://www-cie.iarc.fr/htdocs/monographs/vol77/77-04.html].: “ - - - Coumarin, a known cancer-causing substance in animals, has in the past been used as a tobacco additive - - - ” [http ://www.pulmonologychannel.com/lungcancer/causes.shtml]. “ - - - Chemicals were isolated from the smoke: Benzopyrene, arsenic, tobacco-associated nitrosamines, coumarin, and a host of other known dangerous substances - - - ” [http://72.14.207.104/search?q=cache:Bwt9NSe5eiYJ:www.smoke-free.ca/pdf_{—}1/Reducing%2520harm%2520increasing%2520profit.pdf+tobacco+coumarin&hl=en].

Health concerns surrounding the use of a highly toxic flavoring compound called coumarin (which causes severe liver damage) began to emerge in the late fifties. Cigarette manufacturers voluntarily removed coumarin from the permitted list in September 1997. Although the controversy is almost four decades old, it serves as a reminder of the bias towards sales over health concerns within the tobacco industry as a whole. In the meantime, it is interesting that in America the manufacturers of all food products intended for human consumption abandoned the use of coumarin during 1953/54 ‘until such time that adequate tests and investigations were completed wherein the use of coumarin may be considered to be deleterious and injurious to health’ [http://www.uata.org.ar/CMCT/documents/ASH-UKadditives.pdf]. The Columbia Journalism Review, (January/February 1996) reported, “Brown and Williamson knowingly continued to use a pipe tobacco flavoring additive known as Coumarin despite laboratory evidence that it caused tumors in the livers of mice”.

The coumarin odorant/flavorants have fallen into disfavor due to the tendency of the non-aromatic double bond to epoxidize followed by ring opening of the epoxide to form hydroxyacetaldehyde moieties according to the following metabolic scheme.

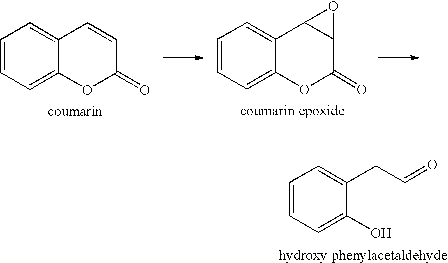

Coumarin epoxide has been implicated in hepatoxocity and genotoxicity. See EFSA Journal (2004) 104, 1-36; Vassallo et al, Toxicological sciences, 82, 26-33 (2004); Born et al, Drug Metabolism and Disposition, 25, 1318-1323 (1997); Born et al, Drug Metabolism and Disposition, 28, 218-223 (2000) and Vassallo et al, Toxicological sciences, 80, 249-257 (2004).

Coumarin, which was first extracted from tonka tree beans in 1820, has long been used by the tobacco industry as an additive in cigarettes [Jacobs M. “The toxicity of coumarin”, The American Perfumer and Essential Oil Review 1953:53-6; Wartman W B. Dolcourin, a coumarin substitute. American Tobacco Company document produced in the case of: State of Minnesota, et al, v. Philip Morris, Inc. et al., No. C1-94-8565, 2^{nd} District Minnesota. Minneapolis:Minnesota Tobacco Document Depository; 3 Jun. 1963. Bates No. ATX02 0004970. Stepka W. Toxicology of coumarin. American Tobacco Company legal document produced in the case of: State of Minnesota, et al, v. Philip Morris, Inc. et al., No. C1-94-8565, 2^{nd} District Minnesota. Minneapolis:Minnesota Tobacco Depository; 3 Sep. 1964. Bates No. MNAT00789559-9562]. The major constituent of tonka beans is coumarin, the compound that Jeff Wigand revealed on “60 Minutes” [a U.S. investigative television program] was still being employed as a tobacco additive, long after it had been shown to be toxic to humans. A Texas herb, probably the Eupatorium incarnatum, is smoked n New Mexico with tobacco, and, having in itself a tonka odor, is said to modify the disagreeable odor of stale tobacco smoke, as taken up by garments and apartments (see Amer. Jour. Pharm., 1868). An aromatic principle, resembling, if not identical with coumarin, has been obtained from Eupatorium incarnatum.

The taste of coumarin, which is like “new-mown-hay”, has been considered by the tobacco industry to be an important additive that significantly enhances the taste [Tobacco Reporter. Coumarin—not good for rats but man uses it differently. Philip Morris legal document produced in the case of: State of Minnesota, et al, v. Philip Morris, Inc. et al., No. C1-94-8565, 2^{nd} District Minnesota. Minneapolis:Minnesota Tobacco Depository; June 1969. Bates No. 2000778146-8148. Palmer A, Ikeda R M, Daylor F L. Coumarin in U.S. cigarettes. Philip Morris legal document produced in the case of: State of Minnesota, et al, v. Philip Morris, Inc. et al., No. C1-94-8565, 2^{nd} District Minnesota. Minneapolis:Minnesota Tobacco Depository; 8 Feb. 1983. Bates No. 1003180427-0437.

Despite its flavor enhancing properties, numerous studies, beginning in 1855, have indicated that coumarin has toxic effects on the nervous system, heart, blood vessels, and liver of animals [Kohler H. Die Beeinflussung Der Grossen Korperfunctionen Durch Coumarin. Centralblatt fur die Medicinischen Wissenschaften 1875;13:867. Kohler H. Eine Thatsachliche Berichtigung Die Vaguslahmende Wirkung Des Cumarins Betreffend. Archiv Fur Experimentelle Pathologie u. Pharmakologie 1877;6:283. Harnack, Witkowski L. Pharmakologische Unterauchungen Uber Das Physostigmen and Calabarin. Archiv Fur Experimentelle Pathologie u Pharmakologie 1876;5:429. Ellinger A. Zur Pharmakodynamischen-dynamischen Charakterisierung Des Cumarins. Archiv Fur Experimentelle Pathologie u. Pharmakologie Suppl. hd. 1908:150. Bergstrom E. Action De La Cumarine Sur Le Systeme Nerveux Autonome. Comptes Rendus Des Saeances De La Sociaetae De Biologie et de Ses Filiales 1925;93:1159-62. Bergstrom E. Recherches Sur Les Proprietes Pharmacologiques Du Coumarin A L'egard Des Organes Isoles Et Mainenus En Survie. Scandinavisches Archiv Fur Physiologie 1928;53:236. Campos FAdM. Contribuicao Ao Estudo Da Accao Phannacologiea Da Fava Tonka Sobre Systema Muscular. Rev. Flora Med (Rio de Janeiro) 1935;1:558. Campos FAdM. “Curarization” by coumarin from tonka bean: effect of coumarin on muscular excitability. Annaes (Faculdade de Medicina Universidade de Sao Paulo) 1935;11:165. Marolda C I. Contribucion al Estudio Farmacodinamico Del Octanol; Accion Sobre El Sistema Circulatorio. Revista de la Associacion Medica Argentina 1936;49:1567. Rai K. Cumarin. Folia Pharmacologica Japanonica 1935;21:86. Chen K K, Steldt F, Fried J, et al. The action of simple lactones related to cardiac aglycones. J Pharm Expl Ther 1942;74:381. Giarman N J. Antibiotic lactones and synthetic analogs. J Pharm Expl Ther 1948;94:232. Giarman N J. Antibiotic lactones and synthetic analogs 11. Cardiotic effects on the isolated frog heart. J Pharm Expl Ther 1949;96:119. Walton R P, Cotten M, McCord W M. Absence of digitalis-like cardiac effects in the action pattern of several simple lactones. Proc Soc Exp Biol Med 1950;74:548. Hazelton L W, Tusing T W, Zeitlin B R, et al. Toxicity of coumarin. J Pharm Expl Ther 1956;1 18:348-59. Hoffmann D, Hoffmann I. The changing cigarette, 1950-1995. J Toxicol Environ Health 1997;50:307-64. Bell J A E, Laing D H. Thermodynamic and kinetic variables in tobacco pyrolysis and their influence on their relationship between smoking and health. British American Tobacco Document. San Francisco: University of California—San Francisco; 5 Nov. 1999. Stanfill S B, Calafat A M, Brown C R, et al. Concentration of nine alkenylbenzenes, coumarin, piperonal, and pulegone in Indian bidi cigarette tobacco. Food and Chemical Toxicology 2003;41:303-17. Vorhees D, Heiger-Bernays W, McClean M. Human health risk associated with cigarette smoke: the link between smoke constituents and additives Boston: The Medical Foundation, 1997. Christakopoulos A, Feldhusen K, Norin H, et al. Determination of natural levels of coumarin in different types of tobacco using a mass fragmentographic Method. Journal of Agricultural Food Chemistry 1992;40:1358-61. Feuer G. The metabolism and biological action of coumarins. Amsterdam: North Holland Publishing Company, 1974], as well as inducing cancerous tumors and toxic conditions in humans [Malewski A. De Camphora, Carbone Sesquichlorato, Cumarino, Vanillique Meletemata [Dissertation]: Dorpat; 1855. Berkanda B, Bouffard-Eyuboglu H, Derman U. The effect of coumarin derivatives on the immunological system of man. Agents and Actions 1983;13:50-2].

In 1954, the US Food and Drug Administration (FDA) banned coumarin in food, but not tobacco products, in the USA based on the results of animal research, including the Hazelton study[Stepka W. Toxicology of coumarin. American Tobacco Company legal document produced in the case of: State of Minnesota, et al, v. Philip Morris, Inc. et al., No. C1-94-8565, 2nd District Minnesota. Minneapolis: Minnesota Tobacco Depository; 3 Sep. 1964. Bates No. MNAT00789559-9562; Hazelton L W, Tusing T W, Zeitlin B R, et al. Toxicity of coumarin. J Pharm Expl Ther 1956; 118:348-59; Feuer G. The metabolism and biological action of coumarins. Amsterdam: North Holland Publishing Company, 1974 and Watson D. Coumarin. Philip Morris legal document produced in the case of: State of Minnesota, et al, v. Philip Morris, Inc. et al., No. C1-94-8565, 2^{nd} District, Minnesota. Minneapolis: Minnesota Tobacco Depository; 16 Apr. 1981. Bates No. 2001307135].

Also, since 1954, many European countries have either banned or greatly restricted coumarin because of its toxic properties [Rylander M R. The toxicology of coumarin. Philip Morris legal document produced in the case of: State of Minnesota, et al, v. Philip Morris, Inc. et al., No. C1-94-8565, 2^{nd} District, Minnesota. Minneapolis: Minnesota Tobacco Depository; 7 Sep. 1981. Bates No. 2023180836-2023180872]. In Norway, like the USA, coumarin has been banned in food, but not in tobacco [Naesheim S. Coumarin in tobacco. Norwegian Directorate for Health and Social Welfare, Department for Tobacco Control, 2002. Dulles F. Norway—Coumarin. Philip Morris legal document produced in the case of: State of Minnesota, et al. v. Philip Morris, Inc. et al., No. C1-94-8565, 2^{nd} District, Minnesota. Minneapolis: Minnesota Tobacco Depository; Bates No. 2501046311A 11 Mar. 1987].

Laboratory studies revealed “impressive evidence” of the capacity of coumarin to produce serious damage to the liver of experimental animals when these animals were fed comparable amounts of coumarin that were added to human food. FDA banned its use as a food additive on Mar. 5, 1954 (19 Federal Register 1239). See also,
http://www.fda.gov/ora/inspect_ref/iom/APPENDICES/appA3.html;
http://www.cspinet.org/reports/chemcuisine.htm;
http://www.foodsafetysite.com/consumers/faq/index.html?m_knowledgebase_article=316 “ - - - Coumarin is an FDA-banned substance that can cause internal hemorrhaging, liver damage and possible cancer - - - ”. Thus, “ - - - concern (has been expressed) over the use of coumarin in pipe tobacco - - - ”
http://www.tobaccofreekids.org/reports/insider/deposition_{—}12.shtml. James A. Duke states in Handbook of Medicinal Herbs (Boca Raton, Fla.: CRC Press, 1985), p 491:
“Leaves (containing coumarin) used to flavor pipe and cigar tobacco and cigarettes . . . and as a moth repellant . . . may cause hemorrhage and liver damage”. Gosselin, Smith, Hodge, and Braddock, Clinical Toxicology of Commercial Products, 5^{th} ed (Baltimore: Williams & Wilkins, 1984), at page II-4 lists toxicity levels of 1-6 (1, 4“practically non-toxic”; 4, “very toxic”; 6, “super-toxic”); nicotine, item 772, pages II-237 and III-311-4 is rated a 6; coumarin, page II-257, item 861, is a 4. Robert Dreisbach and William Robertson, Handbook of Poisoning: Prevention, Diagnosis and Treatment, 12^{th} ed (Norwalk, Conn.: Appleton & Lange, 1983 and 1987), at pages 385-7, cover coumarin. Jay Arena and Richard Drew, Poisoning, 5^{th} ed (Springfield, Ill.: Charles C. Thomas Pub, 1986), at page 999, which lists coumarin, says, ominously, “see Warfarin,” p 1007. It has been reported that “ - - - in the USA from 1954 until 1985 when coumarin was reportedly removed from domestic cigarettes, but not from pipe tobacco until 1996” [http://www.ncbi.nlm.nih.gov/entrez/query.fcgi?cmd=Retrieve&db=PubMed&list_uids=1466 0776&dopt=Abstract].
At http://waynesword.palomar.edu/chemid2.htm: it is reported that “coumarin is also an anticoagulant that represses the synthesis of prothrombin, a plasma protein produced in the liver in the presence of vitamin K. Prothrombin is the precursor of the enzyme thrombin which catalyzes the conversion of fibrinogen to fibrin in the clotting process. Threads of fibrin wind around blood platelets in the damaged area of a blood vessel and provide the framework of a blood clot. Coumarin is converted into the anticoagulant dicoumarin during the improper curing of sweet clover hay from species of Melilotus. Hemorrhaging and death may occur in cattle that eat spoiled sweet clover hay, depending on the amount consumed. Dicoumarin and related drugs are used in human medicines as blood thinners and are commonly used in rodent poisons such as Decon®, which literally cause rats to bleed to death - - - .” A Missouri Attorney General's Office News Release in 2000 stated, “ - - - Big Tobacco laced their products with Coumarin, a type of rat poison, because they thought it would make menthol and other brands taste better - - - ”[http://www.ago.state.mo.us/newsreleases/2000/090600.htm].

The Louisville Courier-Journal reported that “ - - - Coumarin, a common tobacco sweetener, was (known by big tobacco to be a) lung-specific carcinogen - - - ” [http://www.aph.org/aphnew/sweet16.html]. University of Oklahoma Press Release [http://www.aph.org/aphnew/sweet16.html]: “Peer Reviewed Article Documents Placement of Highly Toxic Coumarin in Tobacco Products” by big tobacco. “ - - - Coumarin has been adequately tested by oral administration in two experiments in mice and in one experiment in rats. In mice of one strain, it produced increases in lung tumors (adenomas and carcinomas) in both males and females and in hepatocellular adenomas in females - - - ” [http://www-cie.iarc.fr/htdocs/monographs/vol77/77-04.html].: “ - - - Coumarin, a known cancer-causing substance in animals, has in the past been used as a tobacco additive - - - ” [http://www.pulmonologychannel.com/lungcancer/causes.shtml]. “ - - - Chemicals were isolated from the smoke: Benzopyrene, arsenic, tobacco-associated nitrosamines, coumarin, and a host of other known dangerous substances - - - ” [http://72.14.207.104/search?q=cache:Bwt9NSe5eiYJ:www.smoke-free.ca/pdf_{—}1/Reducing%2520harm%2520increasing%2520profit.pdf+tobacco+coumarin&hl=en].

Despite the lack of regulation of coumarin in tobacco in the USA and Norway, internal tobacco industry documents indicate that industry scientists were conducting ongoing experiments to replace coumarin as a primary flavoring in cigarettes as early as the 1960s [Waterman W B. Dolcourin, a coumarin substitute American Tobacco Company legal document produced in the case of: State of Minnesota, et al. v. Philip Morris, Inc. et al., No. C1-94-8565, 2^{nd} District, Minnesota. Minneapolis: Minnesota Tobacco Depository; Bates No. MNAT00576924. 7 Jun. 1963. Seligman R B. Coumarin in tobacco. Philip Morris legal document produced in the case of: State of Minnesota, et al. v. Philip Morris, Inc. et al., No. C1-94-8565, ₂nd District, Minnesota. Minneapolis: Minnesota Tobacco Depository; Bates No. 2057143630 30 Oct. 1969].

Due to public pressure and government requests to disclose cigarette additives, the tobacco industry was supposed to have voluntarily ceased using coumarin in cigarettes in the USA in 1985 [Palmer A, Ikeda R M, Daylor F L. Coumarin in U.S. cigarettes. Philip Morris legal document produced in the case of: State of Minnesota, et al, v. Philip Morris, Inc. et al., No. C1-94-8565, 2^{nd} District Minnesota. Minneapolis: Minnesota Tobacco Depository; 8 Feb. 1983. Bates No. 1003180427-0437; Campaign for Tobacco Free Kids. Wigand is asked whether Brown & Williamson used rat poison in pipe tobacco; 1995. Wigand J S. Statement of Jeffrey S. Wigand, Ph.D., President of Smoke-Free Kids. In: Public hearings for the Framework Convention on Tobacco Control. Geneva: World Health Organization; 2000. Reynolds R J. Tobacco Company. Statement on Coumarin. R. J. Reynolds legal document produced in the case of: State of Minnesota, et al. v. Philip Morris, Inc. et al., No. C1-94-8565, 2^{nd} District, Minnesota. Minneapolis: Minnesota Tobacco Depository; Bates No 51711 9527 1995. Mintz J. Low tar, high risk. Mother Jones 1983:54-6].

However, despite known severe toxic and carcinogenic risks to humans, coumarin was also reportedly used as an additive in pipe tobacco in the USA at least as late as 1996 [Kurtz H. Details of unaired tobacco story emerge; cigarette firm ex-official told CBS of cancer causing flavor. Washington Post. 18 Nov. 1995:Sect. A03. Nye A. Assessment of the use of coumarin as an additive in pipe tobacco. Brown & Williamson legal document produced in the case of: State of Minnesota, et al. v. Philip Morris, Inc. et al., No. C1-94-8565, 2^{nd} District, Minnesota. Minneapolis: Minnesota Tobacco Depository; Bates No. 503208436-503208452 November 1990. Suber R. Tonka beans and PBS documentary. R J Reynolds legal document produced in the case of: State of Minnesota, et al. v. Philip Morris, Inc. et al., No. C1-94-8565, 2^{nd} District, Minnesota. Minneapolis: Minnesota Tobacco Depository; Bates No. 51742 8707. 13 Mar. 1996].

The reported voluntary removal of coumarin in domestic cigarettes in the USA since 1985 (with one report of one brand containing coumarin in 1991) was due to federal regulatory oversight and widespread public efforts to require that the tobacco industry privately disclose to the US government (due to corporate trade secret considerations) tobacco additives. Despite the reported removal of coumarin from domestic cigarettes, coumarin has been reported to be at high levels in imported Indian bidi cigarettes sold recently in the USA [Stanfill S B, Calafat A M, Brown C R, et al. Concentration of nine alkenylbenzenes, coumarin, piperonal, and pulegone in Indian bidi cigarette tobacco. Food and Chemical Toxicology 2003;41:303-17].

In Norway, there has been, as of December 2002, an ongoing effort to require the tobacco industry to publicly disclose tobacco additives [Naesheim S. Coumarin in tobacco. Norwegian Directorate for Health and Social Welfare, Department for Tobacco Control, 2002; Philip Morris O. Project Coumarin—Top Secret. Philip Morris legal document produced in the case of: State of Minnesota, et al. v. Philip Morris, Inc. et al., No. C1-94-8565, 2^{nd} District, Minnesota. Minnesota; Bates No. 2501046314-6317. 16 Mar. 1987. Robinson J B. Norway. Philip Morris legal document produced in the case of: State of Minnesota, et al. v. Philip Morris, Inc. et al., No. C1-94-8565, 2^{nd} District, Minnesota. Minneapolis: Minnesota Tobacco Depository; Bates No. 2501046311A-6312. 11 Mar. 1987. Ware K. Coumarin. Philip Morris legal document produced in the case of: State of Minnesota, et al. v. Philip Morris, Inc. et al., No. C1-94-8565, 2^{nd} District, Minnesota. Minneapolis: Minnesota Tobacco Depository; Bates No. 2501046313A. 18 Mar. 1987].

Despite the overwhelming evidence of severe health risks related to coumarin, highly public efforts by the Ministry of Health in Norway have been stymied because of tobacco industry assertions that revealing tobacco additives would be a violation of corporate trade secrets (as in the USA). Because the tobacco industry claims that tobacco additives, including coumarin, were immune from public disclosure as corporate trade secrets, full disclosure and regulation to protect the public health was significantly delayed for at least thirty years in the USA and has not yet occurred in Norway.
It is an object of the present invention to provide derivatives of coumarin and related compounds that have reduced toxicity when compared with the compounds on which they are based (the parent compounds) and preferably have a similar odor profile to the parent compounds.

The present invention is provides cyclopropanated coumarin derivatives the formula (I): 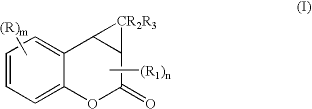
wherein R and R₁ are independently a substituted or unsubstituted, straight or branched alkyl or alkoxy group having up to 5 carbons, phenyl or substituted phenyl; R₂ and R₃ are each independently H or CH₃; m is an integer from 0 to 4, and n is an integer from 0 to 2.

These compounds will be referred to herein after as “the compounds of the invention”.

In the compounds of formula (I), R₂ and R₃ may be the same or different. In other words, both R₂ and R₃ may be H or one of R₂ and R₃ may be H and the other one may be methyl or R₂ and R₃ may both be methyl.

R and R₁ have from 1 to 5 carbon atoms, for example 1, 2, 3, 4 or 5 carbon atoms. Preferably R and R₁ are straight chain or branched alkyl groups such as methyl, ethyl, propyl (e.g. n- or i-propyl) or butyl, (e.g. n-, i- or t-butyl) or pentyl or straight chain or branched alkoxy groups such as methoxy, ethoxy, propoxy (e.g. n- or i-propoxy) or butoxy, (e.g. n-, i- or t-butoxy) or pentoxy.

Examples of the groups R and R₁ include —CH₃, —CH₂CH₃, —CH₂CH₂CH₃, —CH(CH₃)₂, —CH₂CH₂ CH₂CH₃, —CH(CH₃)CH₂CH₃, —CH₂CH(CH₃)₂, —C(CH₃)₃, —OCH₃, —OCH₂CH₃, —OCH₂CH₂CH₃, —OCH(CH₃)₂, —OCH₂CH₂CH₂CH₃, —OCH(CH₃)CH₂CH₃, —OCH₂CH(CH₃)₂, —OC(CH₃)₃.

If the compounds of the invention contain one or more groups R and/or R₁, preferred groups R and/or R₁ include —CH₃, —CCH₃CH₃CH₃, —OCH₃ and —OCH₂CH₃.

m is an integer of from 0 to 4, i.e. 0, 1, 2, 3 or 4. Preferably m is 0, 1 or 2. When m is 2, 3 or 4 each group R may be the same or different. For example, when m is 2 one group R may be —CH₃ and the other one may be —C(CH₃)₃. When m is 2 or greater, the groups R may be present on adjoining carbon atoms or may be spaced apart by one or two carbon atoms.

n is an integer of from 0 to 2, i.e. 0, 1 or 2. When n is 2 each group R₁ may be the same or different.

Examples of compounds of the inventions include compounds having the formulae: 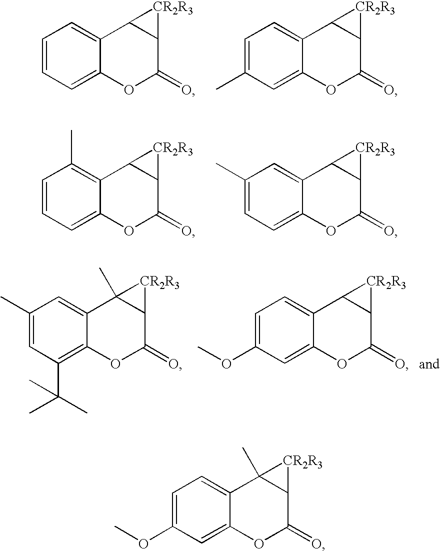
wherein R₂ and R₃ are as defined above. Particularly preferred compounds of the invention are the compounds of the formulae defined above wherein R₂ and R₃ are both H.

Other examples of compounds of the invention include cyclopropanated derivatives of 6-methylcoumarin, 7-methylcoumarin, 4,6-dimethyl-8-tert-butylcoumarin, 7-methoxycoumarin and 4-methyl-7-ethoxycoumarin.

As used herein, by the term “cyclopropanated derivatives” we mean compounds having a cyclopropane ring containing the group CR₂R₃ as defined above.

The odor characters of the compounds of the invention are typically similar to those of the parent benzopyrones of formula (II) 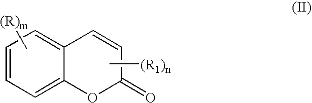
from which they are derived. Preferably, the compounds of the invention are isodonic to the compounds from which they can be derived. By isodonic we include the meaning “having essentially the same odor profile”. It will be appreciated that intensity of the odor of the compounds of the invention may be the same or different to the intensity of the odor of the parent compounds.

In the case of cyclopropanated coumarin, i.e. the compound of formula 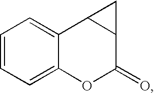
the odor character is sweet, herbaceous-warm, hay-like, and very similar to coumarin.

Without wishing to be bound by theory, it is believed that the compounds of the invention are less toxic than the compounds from which they are derived because cyclopropanation of the non-aromatic double bond prevents formation of an epoxide and ring opening to form hydroxyacetaldehyde moieties.

Compounds of the invention may contain one or more asymmetric carbon atoms and may therefore exhibit optical and/or diastereoisomerism. Diastereoisomers may be separated using conventional techniques, e.g. chromatography or fractional crystallization. The compounds of the invention may be used as a racemic mixture of stereoisomer or may be separated into individual isomers which may then be used separately in pre-selected ratios. The various stereoisomers may be isolated by separation of a racemic or other mixture of the compounds using conventional, e.g. fractional crystallization or HPLC, techniques. Alternatively the desired optical isomers may be made by reaction of the appropriate optically active starting materials under conditions which will not cause racemization or epimerization (i.e. a ‘chiral pool’ method), by reaction of the appropriate starting material with a ‘chiral auxiliary’ which can subsequently be removed at a suitable stage, by derivatization (i.e. a resolution, including a dynamic resolution), for example with a homochiral acid followed by separation of the diastereomeric derivatives by conventional means such as chromatography, or by reaction with an appropriate chiral reagent or chiral catalyst, all under conditions known to the skilled person. All stereoisomers and mixtures thereof are included within the scope of the invention.

The present invention also provides a method for making the compounds of the invention. The compounds of the invention can be made by any suitable cyclopropanation reaction known in the art. One suitable method involves reacting the parent compound of formula (II) 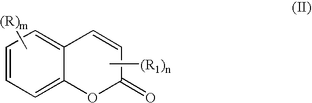
with a trialkylsulfoxonium iodide in which at least one of the alkyl groups is CHR₂R₃ such as trimethylsulfoxonium iodide. This reaction can be illustrated by the following reaction scheme:

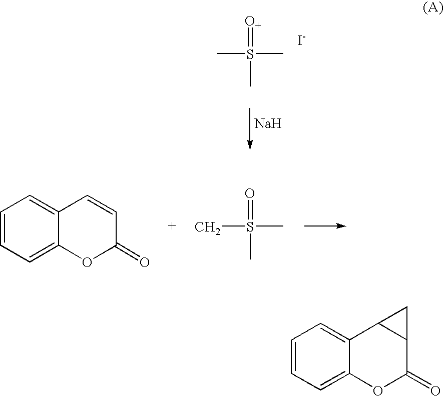

It will be appreciated by those skilled in the art that it may also be possible to prepare the compounds of the invention by methods that do not used a parent compound of formula (II) as a starting material.

The present invention provides for the use of the compounds of the invention and mixtures thereof as a flavor and/or fragrance.

The present invention also provides compositions, products, preparations or articles containing a compound or mixture of compounds of the invention as described above.

The present invention also provides methods to confer, improve, enhance or modify the taste or flavor property of a composition, product, preparation or article which comprises adding thereto a flavor effective amount of a composition or mixture of compounds of the invention as described above.

A method to confer, improve, enhance or modify the aroma, fragrance or odor characteristics of compositions, products, preparations or articles which comprises adding thereto an aroma, fragrance or odor effective amount of a composition or mixture of compounds of the invention as described above is also provided.

The compounds of the invention can be included in virtually any article of manufacture that can include fragrance or flavorant compounds. Examples include hypochlorite (bleach) compositions, detergents, flavorings and fragrances, beverages, including alcoholic beverages, tobacco and tobacco products and the like. The compounds of the invention can be used in applications like soaps, shampoos, denture cleanser tablets, body deodorants and antiperspirants, solid or liquid detergents for treating textiles, fabric softeners, detergent compositions and/or all-purpose cleaners for cleaning dishes or various surfaces, for both household and industrial use. Of course, the use of the compounds is not limited to the above-mentioned products, as they can be used in other current uses in perfumery, namely the perfuming of soaps and bath and shower gels, hygiene or shampoos or other hair-care products, as well as of body odorants, deodorants or antiperspirants, air fresheners, candles and cosmetic preparations, and even in fine perfumery, namely in perfumes and colognes or in tobacco products, liquid or solid fabric detergents or softeners, bleach products (hypochlorites), disinfectants, all-purpose household or industrial cleaners, foods, flavorings, beverages such as beer and soda, denture cleansers (tablets), flavored orally-delivered products such as lozenges, candies, chewing gums, matrices, pharmaceuticals and the like.

The compounds of the invention also find utility in foods, flavorings, beverages such as beer and soda, denture cleansers (tablets), flavored orally-delivered products such as lozenges, candies, chewing gums, matrices, pharmaceuticals and the like. These uses are described in more detail below.

The compounds of the invention can be used as perfuming ingredients, as single compounds or as mixtures thereof. The compounds can be used in their pure state or as mixtures, without added components. The olfactive characteristics of the individual compounds are also present in mixtures thereof, and mixtures of these compounds can be used as perfuming ingredients. This may be particularly advantageous where separation and/or purification steps can be avoided by using compound mixtures.

In all of the above applications, the compounds of the invention can be used alone, in admixture with each other, or in admixture with other perfuming ingredients, solvents or adjuvants of current use in the art. The nature and the variety of these co-ingredients do not require a more detailed description here, which, moreover, would not be exhaustive, and the person skilled in the art will be able to choose the latter through their general knowledge and as a function of the nature of the product to be perfumed and of the desired olfactive effect.

These perfuming ingredients typically belong to chemical classes as varied as alcohols, aldehydes, ketones, esters, ethers, acetates, nitrites, terpene hydrocarbons, sulfur- and nitrogen containing heterocyclic compounds, as well as essential oils of natural or synthetic origin. A large number of these ingredients described in reference textbooks such as the book of S. Arctander, Perfume and Flavor Chemicals, 1969, Montclair, N.J., USA, the contents of which are hereby incorporated by reference in its entirety, or its more recent versions, or in other works of similar nature.

The proportions in which the compounds of the invention can be incorporated in the various products vary within a large range of values. These values depend on the nature of the article or product that one desires to perfume and the odor effect searched for, as well as on the nature of the co-ingredients in a given composition when the compounds are used in admixture with perfuming co-ingredients, solvents or adjuvants of current use in the art.

As an example, the compounds of the invention are typically present at concentrations between about 0.01 and about 30%, or even more, by weight of these compounds relative to the weight of the composition, product or article in which they are incorporated. It will be appreciated that the amount by weight of a compound of the invention in a particular composition or product will depend on the nature of the composition. For example, a washing powder will typically contain less than 1% by weight of a compound of the invention while a fine fragrance may contain more than 20% by weight of a compound of the invention.

The compounds may be used in detergents containing bleaching agents and activators such as, for example, tetraacetylethylenediamine (TAED), hypohalites, in particular hypochlorite, peroxygenated bleaching agents such as, for example, perborates, etc. The compounds can also be used in body deodorants and antiperspirants, for example, those containing aluminum salts. These aspects are described in more detail below.

In addition to the compounds of the invention, the compositions herein may include a detersive surfactant and optionally, one or more additional detergent ingredients, including materials for assisting or enhancing cleaning performance, treatment of the substrate to be cleaned, or to modify the aesthetics of the detergent composition (e.g. perfumes, colorants, dyes, etc.). Non-limiting examples of synthetic detersive surfactants useful herein typically at levels from about 0.5% to about 90%, by weight, include the conventional C₁₋₁₈ alkyl benzene sulfonates (“LAS”) and primary, branch-chain and random C₁₀₋₂₀ alkyl sulfates (“AS”), and the like. Preferred compositions incorporating only synthetic detergents have a detergent level of from about 0.5% to 50%. Compositions containing soap preferably comprise from about 10% to about 90% soap.

The compositions described herein can contain other ingredients such as enzymes, bleaches, fabric softening agents, dye transfer inhibitors, suds suppressors, and chelating agents, all well known within the art.

The compounds of the invention can be incorporated into beverages and impart various flavorings to the beverages. The beverage composition can be a cola beverage composition, and can also be coffee, tea, dairy beverage, fruit juice drink, orange drink, lemon-lime drink, beer, malt beverages, or other flavored beverage. The beverages can be in liquid or powdered form. The beverage compositions can also include one or more flavoring agents; artificial colorants; vitamin additives; preservatives; caffeine additives; water; acidulants; thickeners; buffering agents; emulsifiers; and/or fruit juice concentrates.

Artificial colorants that may be used include caramel color, yellow 6 and yellow 5. Useful vitamin additives include vitamin B2, vitamin B6, vitamin B12, vitamin C (ascorbic acid), niacin, pantothenic acid, biotin and folic acid. Suitable preservatives include sodium or potassium benzoate. Salts that may be used include sodium, potassium and magnesium chloride. Exemplary emulsifiers are gum arabic and purity gum, and a useful thickener is pectin. Suitable acidulants include citric, phosphoric and malic acid, and potential buffering agents include sodium and potassium citrate.

The beverage may, for example, be a carbonated cola beverage. The pH is generally about 2.8 and the following ingredients can be used to make the syrup for these compositions: Flavor Concentrate, including one or more of the compounds of the invention herein (22.22 ml), 80% Phosphoric Acid (5.55 g), Citric Acid (0.267 g), Caffeine (1.24 g), artificial sweetener, sugar or corn syrup (to taste, depending on the actual sweetener) and Potassium Citrate (4.07 g). The beverage composition can be prepared, for example, by mixing the foregoing syrup with carbonated water in a proportion of 50 ml syrup to 250 ml of carbonated water.

Flavored food and pharmaceutical compositions including one or more of the compounds of the invention can also be prepared. The compounds of the invention can be incorporated into conventional foodstuffs using techniques well known to those of skill in the art. Alternatively, the compounds can be incorporated within polymeric particles, which can, in turn, be dispersed within and/or over a surface of an orally-deliverable matrix material, which is usually a solid or semi-solid substrate. When used in chewable compositions, the compounds of the invention can be released into the orally-deliverable polymeric matrix material as the composition is chewed and held in the mouth, thus prolonging the flavor of the composition. In the case of dried powders and mixes, the flavor can be made available as the product is consumed or be released into the matrix material as the composition is further processed. When two flavors are combined with the polymeric particles, the relative amounts of the additives can be selected to provide simultaneous release and exhaustion of the compounds.

Flavored compositions of the invention may include an orally-deliverable matrix material; a plurality of water insoluble polymeric particles dispersed in the orally-deliverable matrix material, where the polymeric particles individually define networks of internal pores and are non-degradable in the digestive tract; and one or more compounds of the invention entrapped within the internal pore networks. The compounds of the invention are released as the matrix is chewed, dissolved in the mouth, or undergoes further processing selected from the group consisting of liquid addition, dry blending, stirring, mixing, heating, baking, and cooking. The orally-deliverable matrix material can be selected from the group consisting of gums, latex materials, crystallized sugars, amorphous sugars, fondants, nougats, jams, jellies, pastes, powders, dry blends, dehydrated food mixes, baked goods, batters, doughs, tablets, and lozenges.

A flavorless gum base can be combined with a compound or a mixture of compounds of the invention to a desired flavor concentration. In one method for producing such gum based products a blade mixer is heated to about 110° F., the gum base is preheated so that it is softened, and the gum base is then added to the mixer and allowed to mix for approximately 30 seconds. The compound or compounds of the invention are then added to the mixer and mixed for a suitable amount of time. The gum can be then removed from the mixer and rolled to stick thickness on waxed paper while warm.

The compounds of the invention may be incorporated into a system that can release a fragrance in a controlled manner. These include substrates such as air fresheners, laundry detergents, fabric softeners, deodorants, lotions, and other household items. The fragrances are generally one or more derivatives of essential oils as described herein, each present in different quantities. U.S. Pat. No. 4,587,129, the contents of which are hereby incorporated by reference in their entirety, describes a method for preparing gel articles that contain up to 90% by weight of fragrance or perfume oils. The gels are prepared from a polymer having a hydroxy (lower alkoxy) 2-alkeneoate, a hydroxy (lower alkoxy) lower alkyl 2-alkeneoate, or a hydroxy poly (lower alkoxy)lower alkyl 2-alkeneoate and a polyethylenically unsaturated crosslinking agent. These materials have continuous slow release properties, i.e. they release the fragrance component continuously over a long period of time. Advantageously, all or a portion of those derivatives that include an aldehyde group can be modified to include an acetal group, which can cause the formulations to release fragrance over a period of time as the acetal hydrolyzes to form the aldehyde compound.

The present invention also provides a composition, product, preparation or article having improved, enhanced or modified aroma, fragrance, odor, flavor and/or taste characteristics comprising (1) a tobacco product selected from natural tobacco, reconstituted tobacco and a tobacco substitute, wrappers for tobacco products, filters for use with tobacco products and mixtures thereof and (2) a compound or mixture of compounds of the invention as defined above.

Such compositions, products, preparations and articles may be designed to be smoked, for example a cigarette or a cigar or may be in the form of snuff or a chewing composition.

A wrapper for a tobacco product, may comprising a cellulose based fiber sheet (i.e. a fiber sheet containing one or more cellulose compounds, including derivatives of cellulose) which is impregnated with a compound of the invention as defined above.

A filter for a tobacco product may comprise a compound of the invention as defined above.

The tobacco containing products of the invention may contain any suitable amount of a compound of the invention. It is preferable that these products comprise up to about 100 ppm of a compound of the invention.

The present invention also provides a method to improve, enhance or modify the aroma, fragrance, odor, flavor and/or taste characteristics of a composition, product, preparation or article comprising natural tobacco, reconstituted tobacco, a tobacco substitute and/or a wrapper for a tobacco product and/or a filter for use with a tobacco product comprising admixing therewith, applying thereto or treating said composition, product, preparation or article with a compound or mixture of compounds of the invention as defined above. Any suitable amount of the compound(s) of the invention may be used in this method. Preferably an amount of up to about 100 ppm is used.

The present invention is illustrated by the following non-limiting example.

### EXAMPLE

In the case of coumarin: NaH (60% mineral oil dispersion, 0.36 g, 9 mmol) was placed in a flask and washed with petroleum ether (2×5 mL) by swirling and decanting. Powdered trimethoxysulfonium iodide (2.0 g, 9 mmol) was then added to the flask and the vessel filled with nitrogen. Anhydrous dimethyl sulfoxide (5 mL) was added carefully until the evolution of hydrogen ceased (1 hour) to produce a milky solution of the ylide. A solution of coumarin (0.98 g) in dimethyl sulfoxide (10 mL) was added dropwise to the ylide. The resulting mixture was heated at 70° C. (the temperature of oil bath) for 4 hours. This was cooled to room temperature, added to water (5 mL), and extracted by diethyl ether (3×50 mL). The combined organic layers were dried over sodium sulfate and evaporated off to yield the crude product. Chromatography was carried out using petroleum ether/ethyl acetate (9:1) to give the pure product as a colorless oily compound. The above example accords with the reaction scheme (A), above.

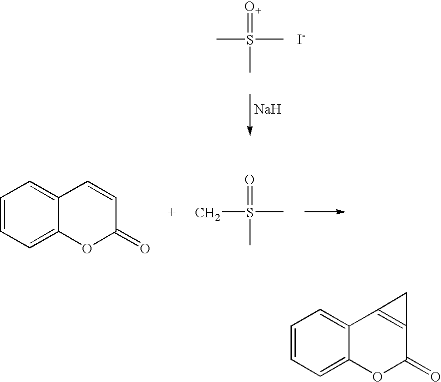

1. A compound or a mixture of compounds of formula (I): 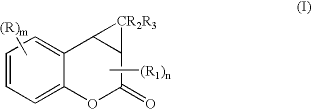
wherein R and R₁ are independently a substituted or unsubstituted, straight or branched alkyl or alkoxy group having up to 5 carbons, phenyl or substituted phenyl; R₂ and R₃ are each independently H or CH₃; m is an integer from 0 to 4, and n is an integer from 0 to 2.

2. A compound according to claim 1 having a formula selected from:

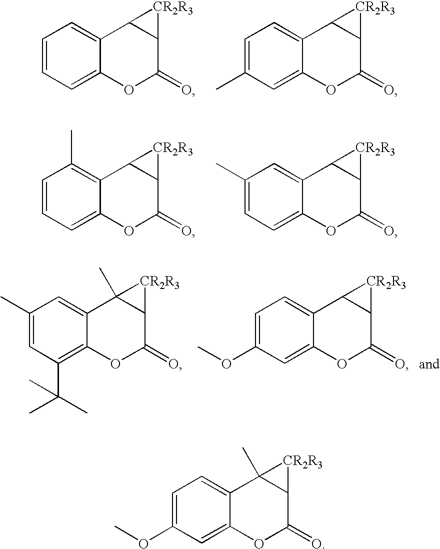

3. A compound according to claim 2, having the formula:

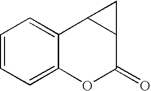

4. A compound according to claim 1, selected from the group consisting of cyclopropanated derivatives of 6-methylcoumarin, 7-methylcoumarin, 4,6-dimethyl-8-tert-butylcoumarin, 7-methoxycoumarin and 4-methyl-7-ethoxycoumarin.

5. The use of a compound according to claim 1 as a flavor or fragrance.

6. A substrate treated with a compound according to claim 1.

7. A method for treating a substrate to impart flavorant/fragrance releasing characteristics thereto comprising treating the substrate with a compound according to claim 1.

8. A composition, product, preparation or article having improved, enhanced or modified aroma, fragrance or odor characteristics comprising a compound or mixture of compounds according to claim 1, optionally in admixture with other perfuming ingredients, solvents, or adjuvants of current use in the art.

9. A composition, product, preparation or article according to claim 8 in the form of a perfume, fragrance or cologne, a soap, a bath or shower gel, a shampoo or other hair care product, a cosmetic preparation, a body odorant, deodorant or antiperspirant, an air freshener, a liquid or solid fabric detergent or softener, bleach product, disinfectant or an all-purpose household or industrial cleaner.

10. A detergent composition, product, preparation or article according to claim 9.

11. A bleach composition, product, preparation or article according to claim 9.

12. A disinfectant composition, product, preparation or article according claim 9.

13. A composition, product, preparation or article according to claim 9 in the form of a body odorant, deodorant or antiperspirant.

14. A composition, product, preparation or article having improved, enhanced or modified flavor or taste characteristics comprising a compound or mixture of compounds according to claim 1.

15. A composition, product, preparation or article according to claim 14 in the form of a beverage, which optionally comprises other beverage ingredients, solvents or adjuvants.

16. A composition, product, preparation or article according to claim 14 in the form of a flavoring, which optionally comprises other flavoring ingredients, solvents or adjuvants.

17. A composition, product, preparation or article according to claim 14 in the form of a food, which optionally comprises other food ingredients, solvents or adjuvants.

18. A composition, product, preparation or article according to claim 14 in the form of a chewing gum, which optionally comprises other chewing gum ingredients, solvents or adjuvants.

19. A composition, product, preparation or article according to claim 14 in the form of a pharmaceutical, which optionally comprises other pharmaceutical ingredients, solvents or adjuvants.

20. A composition, product, preparation or article according to claim 14 in the form of an orally-deliverable matrix material which may optionally comprises other matrix material ingredients, solvents or adjuvants.

21. A method to confer, improve, enhance or modify a taste or flavor property of a composition, product, preparation or article which comprises adding thereto a flavor effective amount of a compound or mixture of compounds according to claim 1.

22. A method according to claim 21, wherein said composition, product, preparation or article is in the form of a beverage, a flavoring, a food, a chewing gum, a pharmaceutical or an orally deliverable matrix.

23. A method to confer, improve, enhance or modify an aroma, fragrance or odor characteristics of a composition, product, preparation or article which comprises adding thereto an aroma, fragrance or odor effective amount of a compound or mixture of compounds as defined in claim 1.

24. A method according to claim 23, wherein said composition, product, preparation or article is in the form of a perfume, a body odorant, deodorant or antiperspirant, a detergent, a bleach product or a disinfectant.

25. An article of manufacture comprising packaging material and an aroma, odor, fragrance, taste or flavor enhancing agent contained within the packaging material, wherein the agent is effective for the enhancement of the aroma, odor, fragrance, taste or flavor of a composition, preparation, product or article to which it is added, and wherein the packaging material comprises a label which indicates that the agent can be used for enhancing aroma, odor, fragrance, taste or flavor, and wherein the agent is a compound or mixture of compounds according to claim 1.

26. A composition, product, preparation or article having improved, enhanced or modified aroma, fragrance, odor, flavor and/or taste characteristics comprising (1) a tobacco product selected from natural tobacco, reconstituted tobacco and a tobacco substitute, wrappers for tobacco products, filters for use with tobacco products and mixtures thereof and (2) a compound as defined in claim 1.

27. A composition, product, preparation or article according to claim 26 comprising a smoking product.

28. A composition, product, preparation or article according to claim 27, which is a cigarette or a cigar.

29. A composition, product, preparation or article according to claim 26 comprising a wrapper for a tobacco product, comprising a cellulose based fiber sheet containing said compound.

30. A composition, product, preparation or article according to claim 26 comprising snuff.

31. A composition, product, preparation or article according to claim 26 comprising a chewing composition.

32. A composition, product, preparation or article according to claim 26 comprising a filter containing said compound.

33. A composition, product, preparation or article according to claim 26 comprising up to about 100 ppm of said compound.

34. A method to improve, enhance or modify the aroma, fragrance, odor, flavor and/or taste characteristics of a composition, product, preparation or article comprising natural tobacco, reconstituted tobacco, a tobacco substitute and/or a wrapper for a tobacco product and/or a filter for use with a tobacco product comprising admixing therewith, applying thereto or treating said composition, product, preparation or article with a compound as defined in claim 1.

35. A method according to claim 34, wherein the amount of said compound is up to about 100 ppm.

36. A method for producing a compound of formula (I) as defined in claim 1, which method comprises cyclopropanating the double bond of the cyclohexane ring in a compound of formula (III): 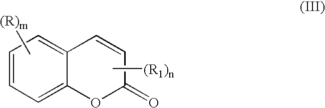
wherein R, R₁, m and n are as defined in claim 1.

37. A method according to claim 36, which comprises reacting the compound of formula (III) with a trialkylsulfoxonium iodide in which at least one of the alkyl groups is CHR₂R₃.
